(19) United States
(12) Patent Application Publication
(10) Pub. No.: US 2008/0020150 A1
(43) Pub. Date: Jan. 24, 2008

(54) DISPLAY DEVICE, METHOD OF MANUFACTURING THE SAME, AND ELECTRONIC APPARATUS INCLUDING THE SAME

(76) Inventors: Wal Hee Kim, Yongin-Si (KR); Sung Min Kim, Yongin-Si (KR); Young Bee Chu, Suwon-Si (KR); Jeong Seok Oh, Seoul (KR); Jeung Soo Kim, Seoul (KR)

Correspondence Address: Frank Chau, Esq.;F. CHAU & ASSOCIATES, LLC, 130 Woodbury Road, Woodbury, NY, 11797, US

(21) Appl. No.: 11/669,249

(22) Filed: Jan. 31, 2007

(30) Foreign Application Priority Data
Jan. 31, 2006 (KR) 10-2006-0009298
Dec. 20, 2006 (KR) 10-2006-0130901

(51) Int. Cl. G02F 1/1335; C09K 19/00

(52) U.S. Cl. 428/1.31

(57) ABSTRACT

A display device includes a display panel comprising a first substrate including a thin film transistor and a pixel electrode, a second substrate including a common electrode, and a liquid crystal provided between a first surface of the first substrate and a first surface of the second substrate, a first polarizing plate provided on a second surface of the second substrate of the display panel, a second polarizing plate provided on a second surface of the first substrate of the display panel, and a first impact absorbing sheet provided between the second surface of the second substrate and the first polarizing plate.

### CROSS-REFERENCE TO RELATED PATENT APPLICATIONS

This application claims priority to Korean Patent Applications No. 2006-0009298, filed on Jan. 31, 2006, and No. 2006-0130901, filed on Dec. 20, 2006, the disclosures of which are incorporated by reference herein in their entireties.

### BACKGROUND OF THE INVENTION

1. Technical Field

The present disclosure relates to a display device and a method of manufacturing the same, and more particularly to a display device capable of protecting a display panel in the display device from an external impact and reducing a thickness of a display module including the display panel and a method of manufacturing the same.

2. Discussion of the Related Art

Portable electronic apparatuses, such as mobile communication terminals, portable game players, and portable multimedia players (PMPs), are used for communications, playing games, listening to music and watching movies. The mobile communication terminals with slim designs have been used.

A flat display panel can be used as a screen of the mobile communication terminals. The flat display panel can be operated at low power, and allows the display device to be thin.

However, since the display panel comprises a brittle material such as glass, deformation or damage can occur on the display panel due to, for example, external pressure or impact. A light transmission cover can be formed on an external surface of a liquid crystal display device to protect the liquid crystal display device. Thick air layers can be formed at both sides of the liquid crystal display device on an internal surface of the light transmission cover. A buffering member can be formed surrounding a circumference of the liquid crystal display device to protect the liquid crystal device from the external impact. However, a thickness of the mobile communication terminal is increased due to the thicknesses of the light transmission cover, the buffering member and the air layers.

### SUMMARY OF THE INVENTION

According to an exemplary embodiment of the present invention, a display device includes a display panel comprising a lower substrate including a thin film transistor and a pixel electrode, an upper substrate including a common electrode, and a liquid crystal provided between an upper surface of the lower substrate and a lower surface of the upper substrate, an upper polarizing plate provided on an upper surface of the upper substrate of the display panel, a lower polarizing plate provided on a lower surface of the lower substrate of the display panel, and an impact absorbing sheet provided between the upper surface of the upper substrate and the upper polarizing plate.

The display device may further include a protective window provided on the upper polarizing plate.

A groove for receiving the upper polarizing plate can be formed in the protective window. At least a portion of the impact absorbing sheet may be inserted into the groove.

The impact absorbing sheet may comprise an acryl-based or silicon-based material.

The impact absorbing sheet may include a core layer, and first and second impact absorbing layers which have an adhesive property and are provided on and under the core layer.

The upper polarizing plate may have a surface hardness of about 3 H or more.

The display device may further include another impact absorbing sheet provided between the lower surface of the lower substrate and the lower polarizing plate. The lower polarizing plate have a surface hardness of about 3 H or more.

The upper and the lower polarizing plates may include a polyvinyl alcohol film, first and second triacetyl cellulose films provided on an upper surface and a lower surface of the polyvinyl alcohol film, and a retarder film provided on a lower surface of the second triacetyl cellulose film.

According to an exemplary embodiment of the present invention, a display device includes a display panel comprising a lower substrate including a thin film transistor and a pixel electrode, an upper substrate including a common electrode, and a liquid crystal provided between an upper surface of the lower substrate and a lower surface of the upper substrate, an upper polarizing plate provided on an upper surface of the upper substrate of the display panel, a lower polarizing plate provided on a lower surface of the lower substrate of the display panel, and impact absorbing sheets provided between the upper surface of the upper substrate and the upper polarizing plate and between the lower surface of the lower substrate and the lower polarizing plate.

The display device may further include protective windows provided on the upper polarizing plate and under the lower polarizing plate. Grooves for receiving the upper and lower polarizing plates may be formed in the protective windows.

The impact absorbing sheets may comprise an acryl-based or silicon-based material.

According to an exemplary embodiment of the present invention, a method of manufacturing a display device includes combining an upper substrate including a thin film transistor and a pixel electrode and a lower substrate including a common electrode, sealing the combined first and second substrates, and injecting liquid crystal between the upper substrate and the lower substrate to produce a display panel, sequentially attaching a polarizing plate and an impact absorbing layer to a protective window, and attaching the protective window to an upper surface of the display panel so that the impact absorbing layer of the protective window comes into contact with the display panel.

The method may further include attaching the protective window to a lower surface of the display panel so that the impact absorbing layer of the protective window contacts the display panel. The method may further include attaching a lower polarizing plate to the lower surface of the display panel.

Attaching the polarizing plate and the impact absorbing layer may include attaching the polarizing plate to the protective window, and attaching the impact absorbing layer to the polarizing plate. Attaching the polarizing plate and the impact absorbing layer may include forming a groove in the protective window, attaching the polarizing plate to the groove, and attaching the impact absorbing layer to the polarizing plate.

According to an exemplary embodiment of the present invention, an electronic apparatus includes a main body, a screen display part combined with the main body, and the screen display part comprising a display device. The display device may include a display panel provided with a lower substrate including a thin film transistor and a pixel electrode, an upper substrate including a common electrode, and a liquid crystal provided between an upper surface of the lower substrate and a lower surface of the upper substrate, an upper polarizing plate provided on an upper surface of the upper substrate of the display panel, a lower polarizing plate provided on a lower surface of the lower substrate of the display panel, and an impact absorbing sheet provided between an upper surface of the upper substrate and the upper polarizing plate.

The electronic apparatus may further include a protective window provided on the upper polarizing plate.

The electronic apparatus may further include another impact absorbing sheet provided between a lower surface of the lower substrate and the lower polarizing plate, and another protective window provided on the lower polarizing plate.

The screen display part may further include a case for receiving the display device.

### BRIEF DESCRIPTION OF THE DRAWINGS

Exemplary embodiments of the present invention can be understood in more detail from the following description taken in conjunction with the accompanying drawings in which:

FIG. 1 is an exploded, perspective view of a display device according to an exemplary embodiment of the present invention;

FIG. 2 is a sectional view of a display device according to an exemplary embodiment of the present invention;

FIG. 3 is a view illustrating a polarizing plate and an impact absorbing sheet according to an exemplary embodiment of the present invention;

FIGS. 4 and 5 are views illustrating a polarizing plate and an impact absorbing sheet according to an exemplary embodiment of the present invention;

FIGS. 6 to 9 are sectional views of a display device according to an exemplary embodiment of the present invention;

FIG. 10 is a perspective view of an electronic apparatus including a display device according to an exemplary embodiment of the present invention; and

FIGS. 11 to 13 are perspective views of electronic apparatuses according to an exemplary embodiment of the present invention.

### DESCRIPTION OF EXEMPLARY EMBODIMENTS

Exemplary embodiments of the present invention will be understood below in more detail with reference to the accompanying drawings. The present invention may be embodied in many different forms and should not be construed as limited to the embodiments set forth herein.

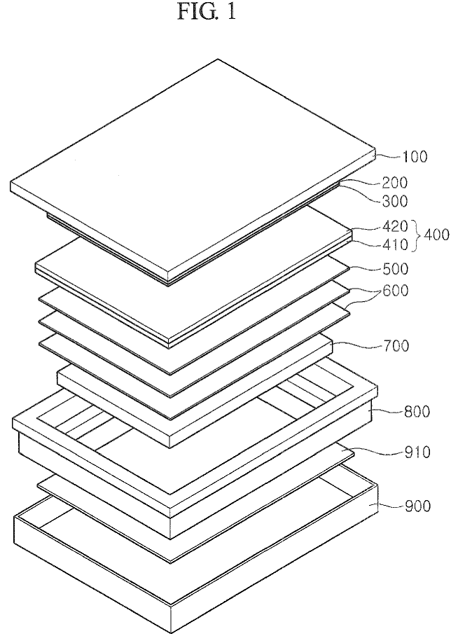

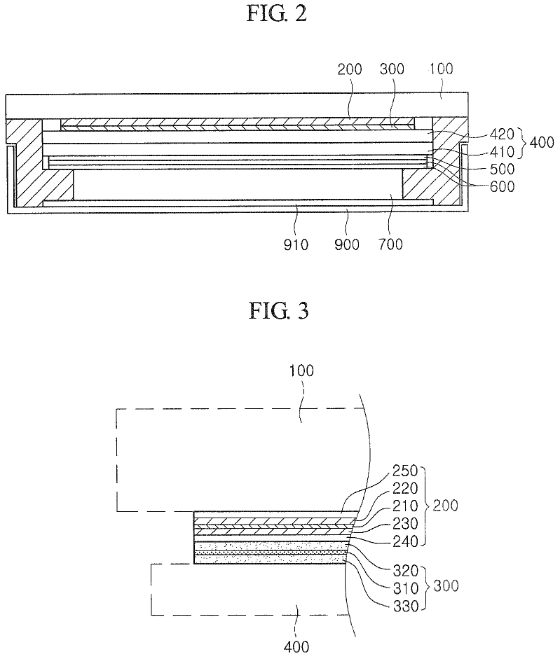

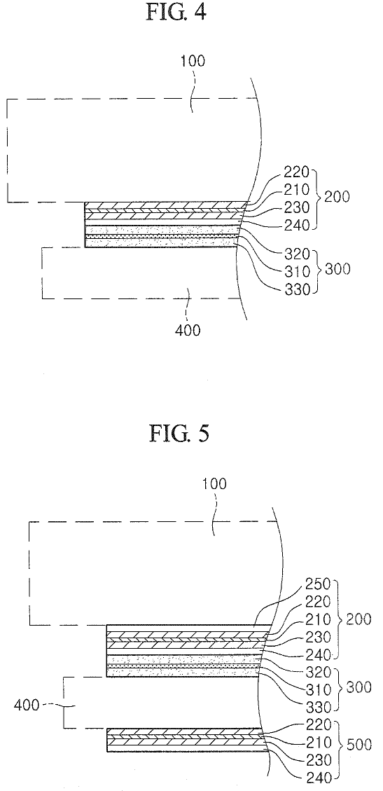

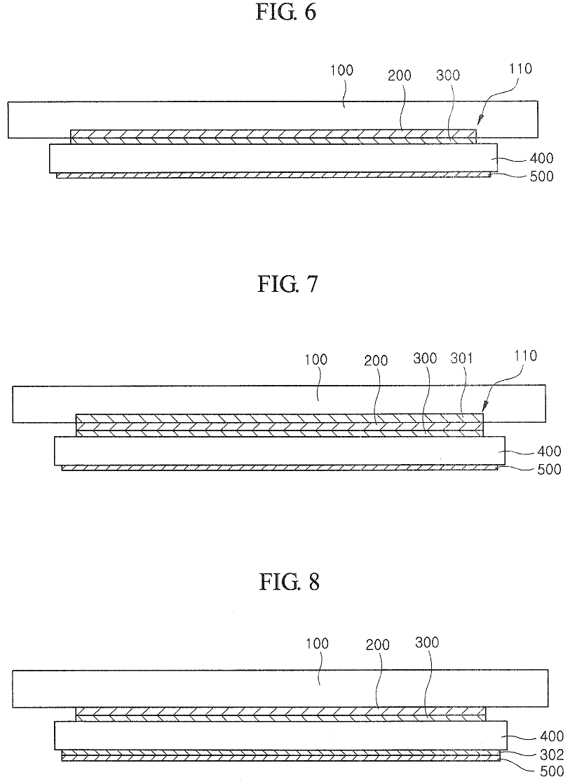

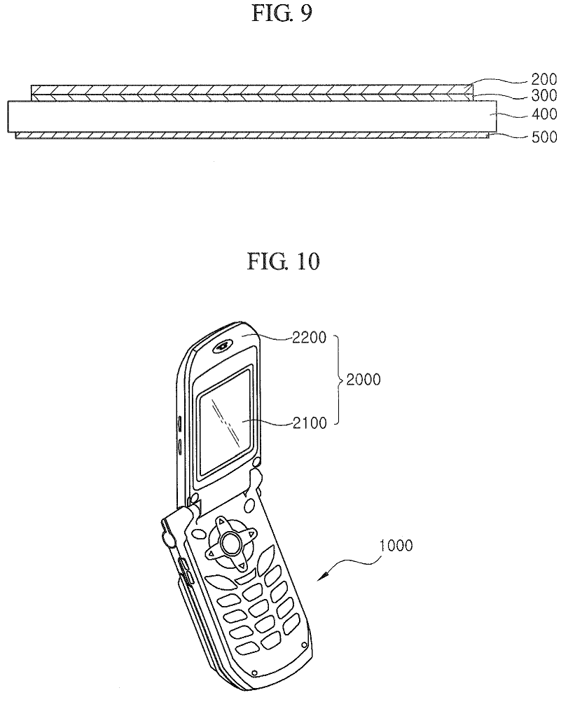

FIG. 1 is an exploded perspective view of a display device according to an exemplary embodiment of the present invention. FIG. 2 is a sectional view of a display device according to an exemplary embodiment of the present invention. FIG. 3 is a view illustrating a polarizing plate and an impact absorbing sheet according to an exemplary embodiment of the present invention. FIGS. 4 and 5 are views illustrating a polarizing plate and an impact absorbing sheet according to an exemplary embodiment of the present invention. FIGS. 6 to 9 are sectional views of a display device according to an exemplary embodiment of the present invention.

With reference to FIGS. 1 to 9, the display device according to an exemplary embodiment includes a display panel 400 showing an image, upper and lower polarizing plates 200 and 500 disposed on an upper part and a lower part of the display panel 400, an impact absorbing sheet 300 interposed between the upper polarizing plate 200 and the display panel 400, and a protective window 100 attached to the upper polarizing plate 200. The display device includes an optical sheet 600 and a back light unit 700 provided under the lower polarizing plate 500, a mold frame 800 supporting the back light unit 700, the optical sheet 600, and the display panel 400, and a receiving member 900 receiving the mold frame 800.

The display panel 400 is provided with a lower substrate 410 in which a pixel electrode (not shown) is provided, an upper substrate 420 in which a common electrode (not shown) is provided, and a liquid crystal (not shown) that is provided between the lower substrate 410 and the upper substrate 420.

The upper substrate 420 includes a black matrix and red, green, and blue color filters that are provided under an insulating substrate comprising a transparent insulating substance such as glass to prevent interference of light between cell regions, an overcoat layer that is provided on the color filters and comprising an organic substance, and the common electrode that is provided on the overcoat layer and comprises a transparent conductive substance such as indium tin oxide (ITO) or indium zinc oxide (IZO).

The lower substrate 410 includes a plurality of gate lines that are arranged in one direction at regular intervals, a plurality of source lines that are arranged at regular intervals to be perpendicular to the gate lines, a plurality of pixel electrodes that are provided in a matrix form in a pixel region defined by the gate lines and the source lines intersecting, and a plurality of thin film transistors switched by a signal applied to the gate lines to transfer the signal from the source lines to the pixel electrodes. The thin film transistor includes a gate electrode, a gate insulating layer, an active layer, an ohmic contact layer, a source electrode, and a drain electrode. The lower substrate also includes a protective layer that insulates the thin film transistor from the pixel electrode.

The display panel 400 can be produced by attaching the lower substrate 410 and the upper substrate 420 using a sealing member (not shown) such as a sealant and providing the liquid crystal between the lower substrate 410 and the upper substrate 420. In the display panel 400, an electric field is changed between the pixel electrode and the common electrode to change the arrangement of the liquid crystals, thus adjusting the transmittance of light. As a result, the image is displayed.

The display device according to an exemplary embodiment of the present invention includes a gate driving circuit part that transmits a gate signal to a plurality of gate lines, and a data driving circuit part that transmits a data signal to a plurality of data lines. The gate driving circuit part and the data driving circuit part are not shown. The gate driving circuit part and the data driving circuit part are provided on a printed circuit board to be connected through the flexible printed circuit board to the display panel 400. The gate driving circuit part may be provided on the lower substrate 410 of the display panel 400. A control part may be provided on the printed circuit board to control the gate driving circuit part and the data driving circuit part.

A protective window 100 to which the upper polarizing plate 200 and the impact absorbing sheet 300 are attached is provided on the upper part of the display panel 4 00. The lower polarizing plate 500 is provided under the display panel 400. The protective window 100 is disposed on the upper surface of the display panel 400, which is formed opposite to the surface on which the common electrode of the upper substrate 420 is formed. The lower polarizing plate 500 is disposed on the lower surface of the display panel 400, which is formed opposite the surface on which the pixel electrode of the lower substrate 410 is formed.

A polarized light refers to a light beam that is substantially vibrated in a predetermined direction among light beams perpendicular to a progress direction of light. Among incident lights vibrating in various directions, a light vibrating in a predetermined direction penetrates the polarizing plates 200 and 500, and other types of light are absorbed by the polarizing plates 200 and 500. The birefringence of the liquid crystal is used in the display panel 400 according to an exemplary embodiment of the present invention. Accordingly, the polarizing plates 200 are disposed on and under the display panel 400.

The polarizing plates 200 and 500 provided on and under the display panel 400 are described with reference to FIG. 3. Referring to FIG. 3, the upper polarizing plate 200 includes a polyvinyl alcohol (PVA) film 210 dyed by a dichroic element, first and second triacetyl cellulose (TAC) films 220 and 230 provided on and under the PVA film 210, a surface reinforcing layer 250 provided on the first TAG film 220, and a retarder film 240 provided under the second TAC film 230.

Examples of the dichroic element include iodine or a dye. The direction of a polarization axis of the polarizing plate 200 may be changed according to a stretching direction of the dichroic element, which dyes the PVA film 210. The first and the second TAC films 220 and 230 act as supporters, which support the PVA film 210. The surface reinforcing layer 250 may include at least one of an anti-glare layer, an anti-reflection layer, and a hard coating layer. The retarder film 240 delays a phase of light that penetrates the retarder film 240. For example, when the central axis of the retarder film 240 and the polarization axis of the polarizing plate 200 converge at an angle of 45 degrees, the phase of light that penetrates the retarder film 240 is delayed by λ/4 (λ is a wavelength).

The manufacture of the polarizing plate 200 is described below. The PVA film 210 is dyed with the dichroic element and stretched. Subsequently, rolls of the first and the second TAC films 220 and 230 are attached to the upper and the lower sides of a roll of the PVA film 210 using, for example, a roller. The retarder film 24 0 is then attached to the lower side of the second TAC film 230 using the roller. The anti-glare layer, the anti-reflection layer, and the hard coating layer are formed on the first TAC film 220 by a surface treatment process. The films may be attached to each other using an adhesive agent. The polarizing place 200 has a surface hardness enough to protect the surface thereof while the polarizing plate 200 contacts external structures. The surface hardness of the polarizing plate is subjected to the surface treatment process. In an exemplary embodiment, the surface hardness of the polarizing plate 200 can be about 4 H or more. The term “H” is an initial letter of hardness, and is used as a unit of hardness. The hardness is increased as H is increased. For example, the hardness of a diamond is considered 10 H. When the polarizing plate 200 having the surface hardness of about 3 H or more is used, the surface of the polarizing plate 200 may be protected while an additional protective sheet is not used. Accordingly, the occurrence of scratches may be prevented on the surface of the polarizing plate 200. Therefore, the polarizing plate 200 according to an exemplary embodiment of the present invention has a surface hardness of about 3 H or more.

In an exemplary embodiment, the surface reinforcing layer 250 may be omitted. Since the additional protective window 100 is attached to the upper side of the polarizing plate 200, the surface reinforcing layer 250 may be omitted. As described above, the formation of the surface reinforcing layer 250 may be omitted in the polarizing plate 200 to reduce the number of processes for manufacturing the surface reinforcing layer 250 or to reduce the thickness of the polarizing plate 200. In an exemplary embodiment, the retarder film 240 may be omitted. Referring to FIG. 5, the polarizing plate 500 provided under the display panel 400 includes the PVA film 210, the first and the second TAC films 220 and 230, which support the PVA film 210, and the retarder film 240 provided under the second TAC film 230. The polarizing plate 500 provided under the display panel 400 may be a known polarizing plate, which is applied to the display panel 400.

The impact absorbing sheet 300 can be attached to the lower side of the upper polarizing plate 200.

The impact absorbing sheet 300 is used to protect the display panel 400 from an external impact. In an exemplary embodiment, the impact absorbing sheet 300 may comprise a transparent substance capable of absorbing and reducing the impact. The impact absorbing sheet 300 may comprise an acryl-based or silicon-based material that has excellent durability or impact absorbing ability. When the impact is applied to the impact absorbing sheet 300, the impact absorbing sheet 300 absorbs the impact so that the display panel 400 is not affected. The impact absorbing sheet 300 prevents the display panel 400 from being broken or deformed due to the external impact. Preferring to FIGS. 3 and 4, the impact absorbing sheet 300 is provided with a core layer 310, and first and second impact absorbing layers 320 and 330 that are disposed on and under the core layer 310. The first impact absorbing layer 320 of the impact absorbing sheet 300 can be attached to the lower side of the upper polarizing plate 200 such as the retarder film 240. In an exemplary embodiment, the first and the second impact absorbing layers 320 and 330 have adhesive properties. Accordingly, the impact absorbing sheet 300 may be attached to the lower side of the upper polarizing plate 200 without using an additional adhesive agent. In an exemplary embodiment, the roll of the upper polarizing plate 200 is attached to the roll of the impact absorbing sheet 300 using the rollers. The impact absorbing sheet 300 and the upper polarizing plate 200 attached to each other are cut to a predetermined size. In an exemplary embodiment, the upper polarizing plate 200 and the impact absorbing sheet 300 may be cut to a predetermined size and then attached to each other.

The upper polarizing plate 200 to which the impact absorbing sheet 300 is attached is attached to the protective window 100.

In an exemplary embodiment, the protective window 100 may comprise a light transmission substance having high strength. For example, the protective window 100 may comprise a plastic or acryl-based substance, which has the light transmission of 80% or more. In an exemplary embodiment, the protective window 100 can be attached to the upper polarizing plate 200 combined with the impact absorbing sheet 300. Impurities can be removed from the attachment surface of the protective window 100 by a washing process using, for example, plasma. Subsequently, the upper polarizing plate 200 combined with the impact absorbing sheet 300 is attached to the attachment surface of the protective window 100. In an exemplary embodiment, the attachment of the protective window 100 and the upper polarizing plate 200 can be performed using an adhesive agent. After an end of the upper polarizing plate 200 is attached to the attachment surface of the protective window 100, a middle portion of the upper polarizing plate is attached to the attachment surface of the protective window 100, and another end of the upper polarizing plate 200 is attached to the protective window 100 using the rollers to prevent defects such as bubbles from being formed on the interface of the upper polarizing plate 200 and the protective window 100.

The protective window 100 to which the upper polarizing plate 200 and the impact absorbing sheet 300 are attached may be attached to the display panel 400 to prevent the breaking or deformation of the display panel 400 due to the external impact. That is, when the external physical impact is applied to the protective window 100, the impact may be reduced due to the protective window 100 and the impact absorbing sheet 300 to protect the display panel 400. When the display panel 400 is exposed, scratches may be formed on the surface of the display panel 400 when the display panel 400 contacts external structures. The protective window 100 may protect the scratches from being formed on the display panel 400. Since the protective window 100 to which the polarizing plate 200 and the impact absorbing sheet 300 are attached may be used instead of the light transmission cover protecting a display region of the display device, it is possible to reduce the whole size of the display device, slim the display device, improve brightness, simplify the process of manufacturing the electronic apparatus, and reduce production cost. Thereby, the productivity can be improved.

Referring to FIG. 2, the protective window 100 to which the upper polarizing plate 200 and the impact absorbing sheet 300 are attached is attached to the upper surface of the display panel 400.

The second impact absorbing layer 330 of the impact absorbing sheet 300 is attached to the upper surface of the upper substrate 420 of the display panel 400. As described above, since the second impact absorbing layer 330 has an adhesive property, an additional adhesive agent does not need to be used. The impurity can be removed from the upper surface of the upper substrate 420 by a predetermined washing process using, for example, plasma before the second impact absorbing layer 330 and the upper substrate 420 are attached to each other.

As described above, the impact absorbing sheet 300, the upper polarizing plate 200, and the protective window 100 are sequentially disposed on the upper surface of the display panel 400 according to an exemplary embodiment of the present invention. The display panel 100 includes a display region, which displays an image and a peripheral circuit region, which provides signals to the display region. Referring to FIGS. 1 and 2, the impact absorbing sheet 300 and the upper polarizing plate 200 can have the same size as the display region of the display panel 400, and the protective window 100 can have a size larger than that of the entire display panel 400. The impact absorbing sheet 300 and the upper polarizing plate 200 may have the same size as the display panel 400.

Referring to FIG. 6, a predetermined groove 110 is formed on a side of the protective window 100 to which the upper polarizing plate 200 is attached. The upper polarizing plate 200 may be inserted into the groove 110. Due to the insertion of the upper polarizing plate 200 into the groove 100, the thickness of the whole protective window 100 to which the upper polarizing plate 200 and the impact absorbing sheet 300 are attached may be reduced. When the upper polarizing plate 200 is inserted into the groove 110 of the protective window 100, since the protective window 100 functions to protect the PVA film 210 of the upper polarizing plate 200, a portion of the films that constitute the upper polarizing plate 200 may be omitted. For example, TAC film and the surface reinforcing layer 250, which are attached to the upper side of the PVA film 210 to protect the PVA film 210 may be omitted. A portion of the impact absorbing sheet 300 may be inserted in the groove 110 in conjunction with the upper polarizing plate 200. The impact absorbing sheet 300 may be provided in the region between the upper polarizing plate 200 and the protective window 100. The thickness of the module in which the upper polarizing plate 200 and the impact absorbing sheet 300 are attached to the lower part of the protective window 100 is about 0.13 mm. When the groove 110 is formed on the protective window 100 and the upper polarizing plate 200 and/or the impact absorbing sheet 300 are inserted into the groove 110, the thickness of the module may be reduced to about 0.08 to about 0.12 mm. Referring to FIG. 7, the impact absorbing sheets 300 and 301 may be provided on the upper and the lower surfaces of the upper polarizing plate 200. The impact absorbing sheets 300 and 301 may improve the impact absorption. Referring to FIG. 8, an additional impact absorbing sheet 302 may be provided in the region between the lower polarizing plate 500 and the display panel 400. Although not shown in the drawing, the lower polarizing plate 500 to which the impact absorbing sheet is attached may be attached to the display panel 400 in conjunction with the protective window 100. When the double-sided display panel in which both sides of the display panel 400 are used for displaying, the protective window 100 to which the impact absorbing sheet 302 and the polarizing plate 500 are attached may be disposed on the upper surface and the lower surface of the display panel 400 to protect the display panel 400 from the external impact. Thus, the display device including the double-sided display panel may be slim. The impact absorbing sheet 300 may be provided on the surface of the lower polarizing plate 500 that does not contact the display panel 400. Referring to FIG. 9, the protective window 100 may be omitted. The hardness of the upper polarizing plate 200 can be about 3 H or more to prevent the occurrence of scratches and to protect the display panel 400 from an external impact. Thus, the thickness of the whole display device may be reduced.

A plurality of optical sheets 600 and a back light unit 700 are provided on the lower side of the display panel 400 in which the impact absorbing sheet 300, the upper polarizing layer 200, and the protective window 100 are sequentially attached to the upper side thereof, and the lower polarizing plate 500 is attached to the lower side thereof.

At least one diffusion plate or brightness improving plate may be used as the optical sheet 600. The diffusion plate guides light emitted from the back light unit 700 to progress toward the front side of the display panel 400, and diffuses light to achieve uniform distribution in a wide region. The diffusion plate may comprise a film including a transparent resin. Both sides of the film are coated with a predetermined light diffusion member. The brightness improving plate causes the light beam being parallel to the penetration axis thereof to penetrate, and reflects the light beam that being perpendicular to the penetration axis thereof, thereby improving brightness.

The back light unit 700 can be an edge type including a light source (not shown) and a light guide plate (not shown). The back light unit may be a direct type in which a plurality of light sources (not shown) are disposed on a same side. A cold cathode fluorescent lamp (CCFL) or a light emitting diode (LED) may be used as the light source.

The mold frame 800 supporting the back light unit 700, the optical sheet 600, and the display panel 400 can have an empty frame shape. Predetermined protrusions 810 are provided at a lower part of an internal side of a wall of the frame 800, and the back light unit 700 is disposed to the region between the protrusions to be supported. The optical sheets 600 and the display panel 400 are provided on the upper sides of the protrusions 810. Referring to FIG. 2, the protective window 100 contacts the upper side of the mold frame 800. In an exemplary embodiment, the mold frame 800 may be omitted. The shape of the mold frame 800 may be changed to fix the protective window 100 to the inside of the mold frame 800.

In an exemplary embodiment, a receiving member 900 is provided to receive the mold frame 800. A reflection plate 910 can be disposed on the bottom of the receiving member 900. The receiving member 900 may be omitted according to an exemplary embodiment of the present invention. When the receiving member 900 is omitted, the mold frame 800 and the reflection plate 910 provided under the mold frame 800, may function as the receiving member 900. The display device having the above-mentioned structure may be produced to have a total thickness of about 2 mm or less. In an exemplary embodiment of the present invention, the display device can be produced to have a total thickness in the range of about 0.7 to about 1.2 mm.

The display panel according to an exemplary embodiment is not limited to a liquid crystal display panel, but various types of display panels such as, for example, plasma display panels and organic electro luminescence panels may be used. Accordingly, the optical sheets and the back light unit may be omitted according to a type of the display panel.

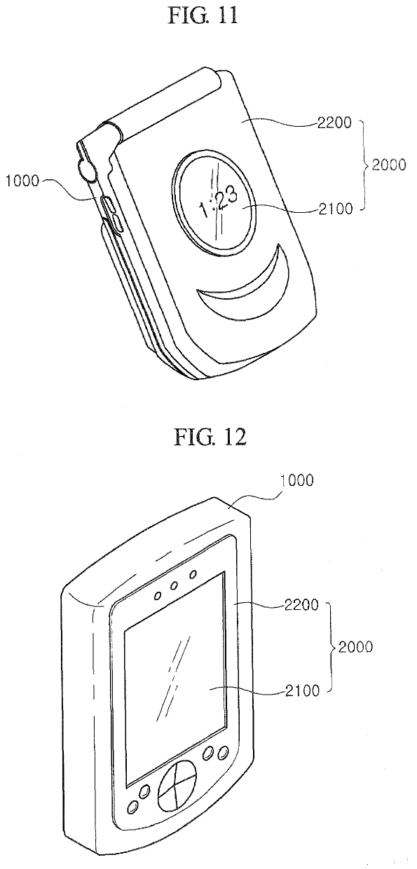

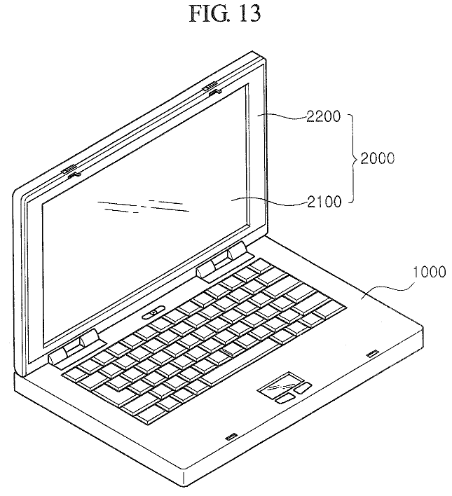

FIG. 10 is a perspective view of an electronic apparatus including a display device according to an exemplary embodiment of the present invention. FIGS. 11 to 13 are perspective views of electronic apparatuses including a display device according to exemplary embodiments of the present invention.

With reference to FIG. 10, the electronic apparatus includes a main body 1000 and a screen display part 2000 in which a display device 2100 is provided. The main body 1000 and the screen display part 2000 can be combined with each other using a folder method. In an exemplary embodiment, the main body 1000 and the screen display part 2000 may be produced as a single unit. The main body 1000 may include a control part controlling the operation of the electronic apparatus and a data storage part. The main body 1000 may further include a wireless data transmission and reception part, a sound treatment part, and a key inputting part according to the characteristic of the electronic apparatus. The screen display part 2000 includes the display device 2100 and a case 2200 that fixes the display device 2100. The display device 2100 includes the display panel 400, the impact absorbing sheet 300 attached to the external part of the display panel 400, the upper polarizing plate 200, and the protective window 100.

The electronic apparatus including the display device 2100 according to an exemplary embodiment may protect the display device 2100 from the external impact using the impact absorbing sheet 300 and the protective window 100 formed on the external surface of the display panel 400. An additional light transmission cover for protecting the display device 2100 can be omitted in the screen display part 2000 due to the high surface hardness of the protective window 100 and the upper polarizing plate 200. Since the light transmission cover is not formed, the thickness of the electronic apparatus can be reduced. Thus, reduction in size and slimness are achieved, the production process is simplified, and the production cost is reduced.

The display device is not limited to the folder type terminal described above, but may be applied to the image display part of the electronic apparatus such as, for example, a flip type of terminal, a slide type of terminal, or a thin plate type of terminal. In an exemplary embodiment of the present invention, the electronic device can display a same image on both sides of the display part or different images on either side of the display part. For example, the display device may be used in the dual folder type of mobile phone as shown in FIG. 11, in the Personal Digital Assistant (PDA) as shown in FIG. 12, or in the notebook computer as shown in FIG. 13. The electronic apparatus may be, for example, a slide type of mobile phone, portable game players, PDAs, Portable Multimedia Players (PMPs), notebook computers, or TVs.

In exemplary embodiments of the present invention, a polarizing plate having high strength in which an impact absorbing sheet is attached to the external surface of a display panel is provided, or a protective window to which the impact absorbing sheet and the polarizing plate are attached is provided on the upper side of the display panel to protect the display panel from the external impact.

In exemplary embodiments of the present invention, since the polarizing plate which has high strength and to which the impact absorbing sheet is attached or the protective window to which the impact absorbing sheet and the polarizing plate are attached is used as a light transmission cover to protect the display device in the electronic apparatus, the thickness of the electronic apparatus is reduced, the process of producing the electronic apparatus is simplified, and the production cost is reduced. As a result, productivity can be improved.

Although exemplary embodiments have been described with reference to the accompanying drawings, it is to be understood that the present invention is not limited to these precise embodiments, but various changes and modifications can be made by one skilled in the art without departing from the spirit and scope of the present invention. All such changes and modifications are intended to be included within the scope of the invention as defined by the appended claims.

What is claimed is:

1. A display device comprising:
a display panel comprising a first substrate including a thin film transistor and a pixel electrode, a second substrate including a common electrode, and a liquid crystal provided between a first surface of the first substrate and a first surface of the second substrate;
a first polarizing plate provided on a second surface of the second substrate of the display panel;
a second polarizing plate provided on a second surface of the first substrate of the display panel; and
a first impact absorbing sheet provided between the second surface of the second substrate and the first polarizing plate.

2. The display device of claim 1, further comprising:
a protective window provided on the first polarizing plate.

3. The display device of claim 2, wherein a groove for receiving the first polarizing plate is formed in the protective window.

4. The display device of claim 3, wherein at least a portion of the first impact absorbing sheet is inserted into the groove.

5. The display device of claim 1, wherein the first impact absorbing sheet comprises an acryl-based or silicon-based material.

6. The display device of claim 1, wherein the first impact absorbing sheet includes:
a core layer; and
first and second impact absorbing layers having an adhesive property and provided on and under the core layer.

7. The display device of claim 1, wherein the first polarizing plate has a surface hardness of about 3 H or more.

8. The display device of claim 1, further comprising:
a second impact absorbing sheet provided between the second surface of the first substrate and the second polarizing plate.

9. The display device of claim 8, wherein the second polarizing plate has a surface hardness of about 3 H or more.

10. The display device of claim 1, wherein the first and the second polarizing plates include:
a polyvinyl alcohol film;
first and second triacetyl cellulose films provided on a first surface and a second surface of the polyvinyl alcohol film; and
a retarder film provided on a first surface of the second triacetyl cellulose film.

11. The display device of claim 10, wherein the first polarizing plate includes a surface reinforcing layer provided on the first triacetyl cellulose film.

12. The display device of claim 11, wherein the surface reinforcing layer includes at least one of an anti-glare layer, an anti-reflection layer, and a hard coating layer.

13. A display device comprising:
a display panel comprising a first substrate including a thin film transistor and a pixel electrode, a second substrate including a common electrode, and a liquid crystal provided between a first surface of the first substrate and a first surface of the second substrate;
a first polarizing plate provided on a first surface of the second substrate of the display panel;
a second polarizing plate provided on a first surface of the first substrate of the display panel; and
impact absorbing sheets provided between the first surface of the second substrate and the first polarizing plate and between the first surface of the first substrate and the second polarizing plate.

14. The display device of claim 13, further comprising:
protective windows provided on the first, polarizing plate and under the second polarizing plate.

15. The display device of claim 14, wherein grooves for receiving the first and second polarizing plates are formed in the protective windows.

16. The display device of claim 13, wherein the impact absorbing sheets comprise an acryl-based or silicon-based material.

17. A method of manufacturing a display device, the method comprising:
combining a first substrate including a thin film transistor and a pixel electrode and a second substrate including a common electrode;
sealing the combined first, and second substrates;
injecting liquid crystal between the first substrate and the second substrate to produce a display panel;
attaching a first polarizing plate and an impact absorbing layer to a protective window; and
attaching the protective window united with the first polarizing plate to a first surface of the display panel so that the impact absorbing layer of the protective window contacts the display panel.

18. The method of claim 17, further comprising:
attaching the protective window to a second surface of the display panel so that the impact absorbing layer of the protective window contacts the display panel.

19. The method of claim 17, further comprising:
attaching a second polarizing plate to the second surface of the display panel.

20. The method of claim 17, wherein attaching the first polarizing plate and the impact absorbing layer comprises:
attaching the first polarizing plate to the protective window; and
attaching the impact absorbing layer to the first polarizing plate.

21. The method of claim 17, wherein attaching the first polarizing plate and the impact absorbing layer comprises:
forming a groove in the protective window;
attaching the first polarizing plate to the groove; and
attaching the impact absorbing layer to the first polarizing plate.

22. An electronic apparatus comprising:
a main body; and
a screen display part combined with the main body, the screen display part comprising a display device,
wherein the display device includes:
a display panel provided with a first substrate including a thin film transistor and a pixel electrode, a second substrate including a common electrode, and a liquid crystal provided between a first surface of the first substrate and a first surface of the second substrate;
a first polarizing plate provided on a second surface of the second substrate of the display panel;
a second polarizing plate provided on a second surface of the first substrate of the display panel; and
a first impact absorbing sheet provided between a second surface of the second substrate and the first polarizing plate.

23. The electronic apparatus of claim 22, further comprising:
a first protective window provided on the first polarizing plate.

24. The electronic apparatus of claim 23, further comprising:
a second impact absorbing sheet provided between the second surface of the first substrate and the second polarizing plate; and
a second protective window provided on the second polarizing plate.

25. The electronic apparatus of claim 22, wherein the screen display part further comprises a case for receiving the display device.
